(19) United States
(12) Patent Application Publication
(10) Pub. No.: US 2010/0002210 A1
(43) Pub. Date: Jan. 7, 2010

(54) INTEGRATED INTERFERENCE-ASSISTED LITHOGRAPHY

(75) Inventors: RUDOLF HENDEL, Los Gatos, CA (US); Kuo-Shih Liu, Fremont, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/200,108

(22) Filed: Aug. 28, 2008

Related U.S. Application Data
(60) Provisional application No. 60/969,230, filed on Aug. 31, 2007.
(60) Provisional application No. 60/969,280, filed on Aug. 31, 2007.

(51) Int. Cl. G03B 27/42

(52) U.S. Cl. 355/53

(57) ABSTRACT

A lithography scanner and track system is provided that includes an interference lithography system according to one embodiment. The scanner provides a first optical exposure of a wafer. The track system provides pre and post-processing functions on a wafer. The interference lithography system may be included within the scanner and may expose a wafer either before or after the first optical exposure. The interference lithography system may also be included within the track system as part of the pre or post processing. The first optical exposure may include optical photolithography.

### CROSS-REFERENCES TO RELATED APPLICATIONS

This application is a nonprovisional, and claims the benefit, of U.S. Provisional Patent Application No. 60/969,230, filed Aug. 31, 2007, entitled “Resolution Enhancement Techniques For Interference-Assisted Lithography,” and of U.S. Provisional Patent Application No. 60/969,280, filed Aug. 31, 2007, entitled “Integrated Interference Assisted Lithography,” the entire disclosure of each of which is incorporated herein by reference for all purposes.

### BACKGROUND

This disclosure relates in general to lithography and, but not by way of limitation, to lithography processing systems that incorporate interference assisted lithography amongst other things.

Various lithography systems have been proposed that provide ever decreasing optical resolution. Interference assisted lithography (IAL) uses multiple lithography systems to expose a wafer. In one example of IAL, an interference lithography (IL) system is employed with an optical photolithography (OPL) system to expose a wafer. Current OPL systems include very large and expensive optics. Accordingly, there is a need to provide for a system that combines an IL system with existing OPL systems as well as provide systems that combine IL and OPL systems.

### BRIEF SUMMARY

A lithography system comprising a scanner and a track. The scanner is configured to exposes a wafer under an optical condition, for example, using photolithography. The track, for example, may include an interference lithography interferometer. The track may also be configured to provide pre-exposure processing of the wafer, provide the wafer to the scanner, provide post-exposure processing of the wafer, and receive the wafer from the scanner. In some embodiments, the interference lithography system may be provided as part of the pre-exposure processing. In other embodiments, the interference lithography system is provided as part of the post-exposure processing. The optical condition, for example, may include extreme ultraviolet lithography, electron beam lithography, and/or optical photolithography.

A lithography scanner comprising a track input means, a first exposure means, a second exposure means, a track output means. The track input may be coupled with a track and configured receive a wafer from a wafer processing track. The first exposure means exposes the wafer using a first lithography technique and the second exposure means exposes the wafer using interference lithography. The track output means is coupled with the track and provides the wafer to the track after exposure.

Another method is provided for exposing a wafer according to one embodiment. Pre-exposure processing of the wafer occurs within a track. The wafer is then exposed with a an interference lithography system within the track. The wafer may then be transferred to a scanner from the track where the wafer is exposed with any of a variety of lithography techniques. The wafer may then be transferred back to the track for post exposure processing.

Another method is provided for exposing a wafer according to one embodiment. Pre-exposure processing of the wafer occurs within a track. The wafer may then be transferred from the track to a scanner whereupon the wafer is exposed using a lithography technique. The wafer is transferred back to the track from the scanner, where the wafer is exposed with an interference lithography system within the track. Post-exposure processing may then occur within the track.

Another method is provided for exposing a wafer according to one embodiment. Pre-exposure processing of the wafer occurs within a track. The wafer may then be transferred from the track to a scanner whereupon the wafer is exposed using a lithography technique. The wafer may then be exposed with an interference lithography system within the scanner. The wafer may then be transferred from the scanner to the track whereupon post exposure processing may occur.

Another method is provided according to some embodiments. The wafer is coated with a photoresist layer within the track and then transferred to an interference lithography system where the wafer is exposed. The interference lithography system may be within the track or a scanner. The wafer may then be transferred back to the track followed by post processing of the wafer. After post processing, the wafer is coated with a second photoresist within the track, whereupon the wafer is transferred to a scanner. At the scanner, the wafer is exposed using a lithography technique. The wafer may then be transferred from the scanner to the track whereupon post exposure processing may occur.

### BRIEF DESCRIPTION OF THE DRAWINGS

FIG. 1A shows an exemplary line pattern achievable using embodiments described herein.

FIG. 1B shows an exemplary latent image of a line pattern produced using an interference lithography (IL) exposure according to one embodiment.

FIG. 1C shows an exemplary optical photolithography (OPL) mask used to expose a substrate in coordination with the IL line pattern shown in FIG. 1B according to one embodiment.

FIG. 1D shows the composite pattern on a substrate using the IL line pattern shown in FIG. 1B and the OPL mask shown in FIG. 1C according to one embodiment.

FIG. 2 shows a block diagram of the flow of a wafer between a track and a scanner according to one embodiment.

FIG. 3 shows a block diagram of the flow of a wafer between a track and a scanner that includes exposing the wafer with an IL system integral to the track prior to providing the wafer to the scanner according to one embodiment.

FIG. 4 shows a block diagram of the flow of a wafer between a track and a scanner that includes exposing the wafer with an IL system integral to the scanner after receiving the wafer from the track and prior to passing it to the scanner according to one embodiment.

FIG. 5 shows a block diagram of the flow of a wafer between a track and a scanner that includes exposing the wafer with an IL system integral to the scanner, after prior exposure in the scanner and prior to providing the wafer back to the track according to one embodiment.

FIG. 6 shows a block diagram of the flow of a wafer between a track and a scanner that includes exposing the wafer with an IL system at the track after receiving the wafer from the scanner according to one embodiment.

FIGS. 7A and 7B show a block diagram of the flow of a wafer between a track and a scanner that includes exposing the wafer with an IL system after preprocessing at the track and prior to exposure at the scanner according to one embodiment.

FIGS. 8A and 8B show a block diagram of the flow of a wafer between a track and a scanner that includes exposing the wafer with an IL system after exposure at the scanner and prior to post-processing at the track according to one embodiment.

FIG. 9 shows a block diagram of the flow of two wafers from two tracks to one scanner with an IL system between the pre-processing portion of the track and the scanner according to one embodiment.

FIG. 10 shows a block diagram of the flow of two wafers from two tracks to one scanner with an IL system between the post-processing portion of the track and the scanner according to one embodiment.

FIG. 11 shows a block diagram of the flow of two wafers from a single track to two scanners with an IL system between the pre-processing portion of the track and the scanner according to one embodiment.

FIG. 12 shows a block diagram of the flow of two wafers from two tracks to one scanner with an IL system at the scanner.

FIG. 13 shows a block diagram of the flow of two wafers from two tracks to one scanner with an IL system at the pre-processing portion of the track.

FIG. 14 shows a block diagram of the flow of two wafers from two tracks to one scanner with an IL system at the post-processing portion of the track.

FIG. 15A shows a block diagram of an interference lithography system according to one embodiment.

FIG. 15B shows a latent exposure pattern from an interference lithography system according to one embodiment.

FIG. 16 shows a diagram of an electron beam apparatus according to one embodiment.

FIG. 17 shows a diagram of an optical photolithography system according to one embodiment.

FIG. 18 shows a diagram of an extreme UV lithography system according to one embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

As used throughout this disclosure, the term “pre-processing” may include applying a photo resist, for example, using a spin coat method, baking, annealing, chemical cleaning, application of adhesion promoters, etc. The term “post-processing” may include post-exposure baking, annealing, development of the photoresist, for example, using a spin coat method, etching, hard baking, etching, annealing, etc.

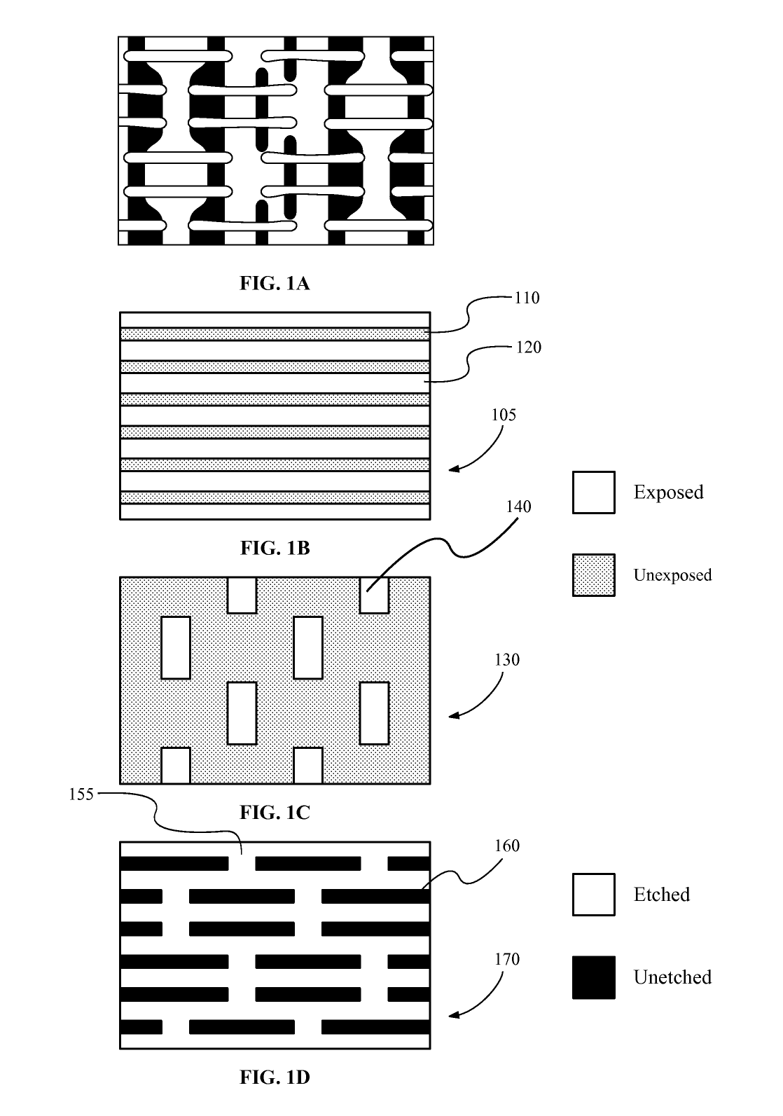

FIG. 1A shows the line patterns of an SRAM cell. This exemplary line pattern may be achievable using, for example, by exposing a wafer with an interference lithography (IL) system and an optical photolithography (OPL) system. For example, the line pattern may be achieved as further shown in FIGS. 1B-1C. FIG. 1B shows an exemplary latent image 105 of a line pattern produced using an IL exposure. A positive photoresist was used. The white spaces 120 were exposed portions and the shaded spaces 110 were not exposed in this first step. Various other lithography techniques may also be used to produce the line pattern shown in the figure. FIG. 1C shows an exemplary optical photolithography (OPL) mask 130 used in a second exposure. The mask 130 permits light to pass through at the white spaces 140 and expose the target. The resulting composite pattern 170 is shown in FIG. 1D. As shown the mask 130 exposed portions 150 of the lines 160 that were previously unexposed. The resulting latent image 170, when baked, developed, etc., will return a line pattern similar to portions of the one shown in FIG. 1A. In other embodiments, the OPL exposure occurs prior to the IL exposure.

Some embodiments may include systems and methods for exposing a wafer under two or more lithography conditions as described in FIGS. 1A-1D. The embodiments of the system may include modification to a track and/or scanner system to include another lithography exposure, for example, including an IL exposure. The track system is a wafer processing tool that provides pre-exposure and post-exposure processing for a wafer. The pre-processing may include applying a photoresist on the wafer, a pre-exposure bake, etc. The post-processing may include, for example, a post exposure bake, and/or etching (dry or wet).

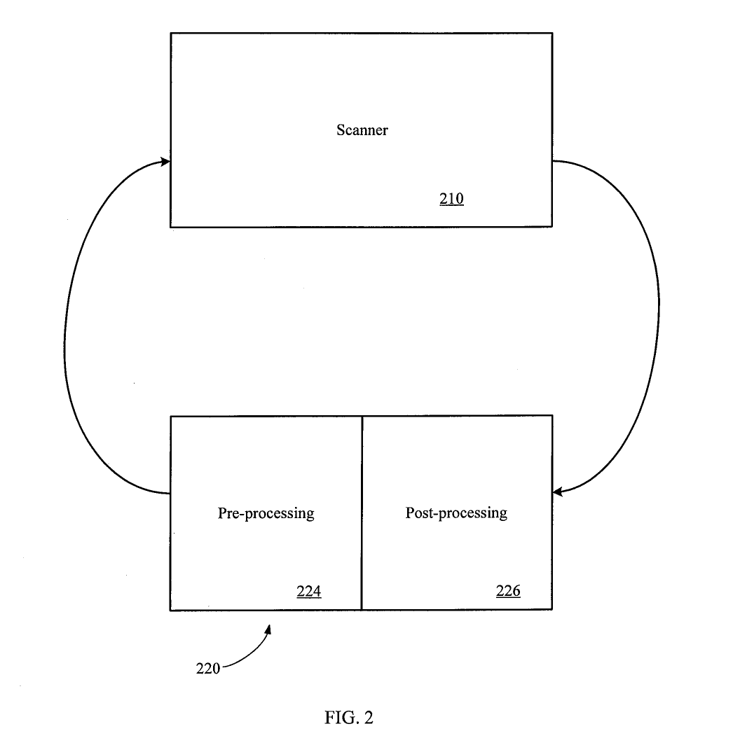

FIG. 2 shows a block diagram of the flow of a wafer between a track 220 and a scanner 210 according to one embodiment. A wafer undergoes pre-processing 224 within the track prior to being transferred to the scanner 210. After the wafer has been exposed within the scanner 210, the wafer undergoes post-processing 226 within the track system 220. The scanner 210 may include various optical systems. In one embodiment, the scanner 210 includes an OPL scanner.

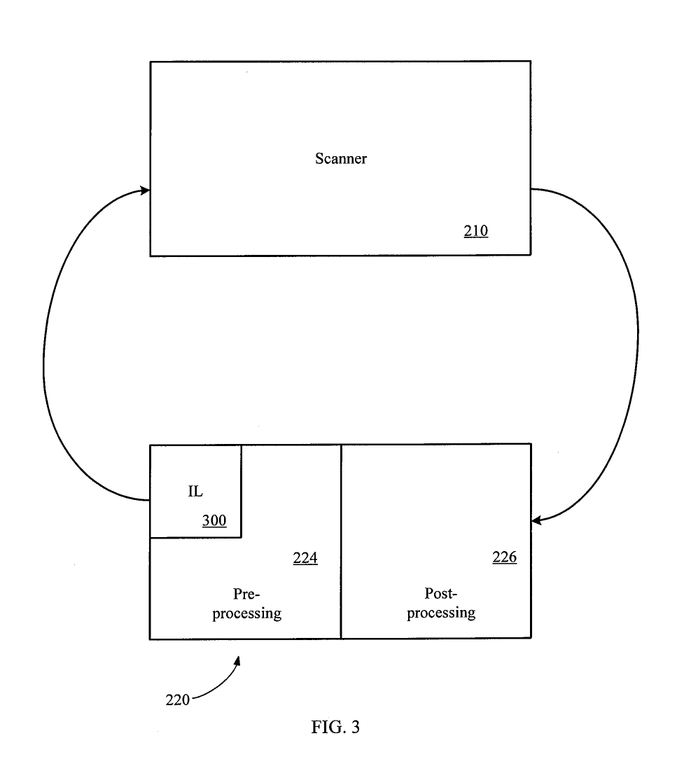

FIG. 3 shows a block diagram of the flow of a wafer between a track 220 and a scanner 210 that includes exposing the wafer with an IL system 300 at track 220 prior to providing the wafer to the scanner 210 according to one embodiment. Accordingly, the track includes, for example, an IL interferometer as part of the IL system 300 that exposes the wafer prior to the wafer being transferred to the scanner 210. In such embodiments, the system may provide two exposures using two systems between pre-processing and post-processing. For example, an IL exposure may occur within the IL system 300 and an OPL exposure may occur within the scanner 210.

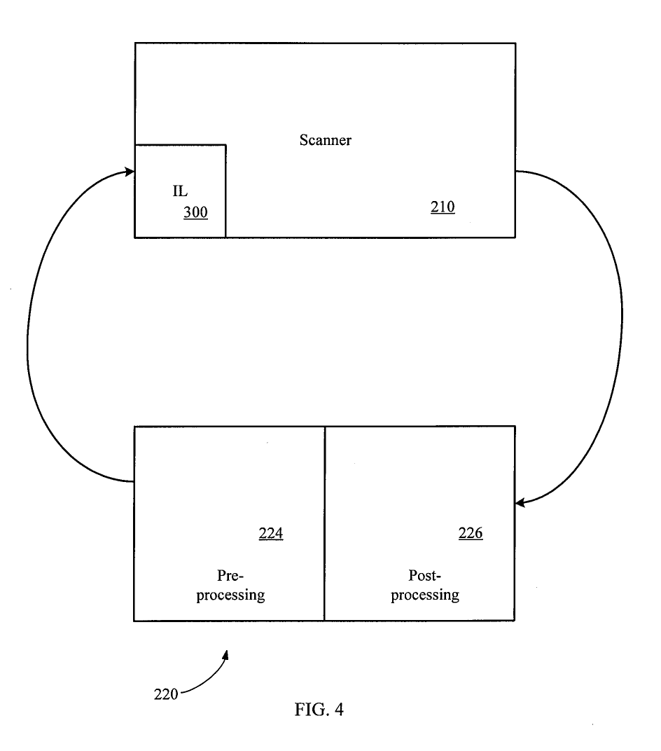

FIG. 4 shows a block diagram of the flow of a wafer between a track 220 and a scanner 210 that includes exposing the wafer with an IL system 300 at the scanner 210 after receiving the wafer from the track 220 according to one embodiment. Accordingly, in this embodiment, the optics, such as the laser, may be configured to provide illumination for both the OPL and IL exposures. In other embodiments, the two exposures may use different illumination sources with the same or different wavelength. In this embodiment, the IL exposure occurs first followed by the OPL exposure. In other embodiments, the two exposures may use different illumination sources.

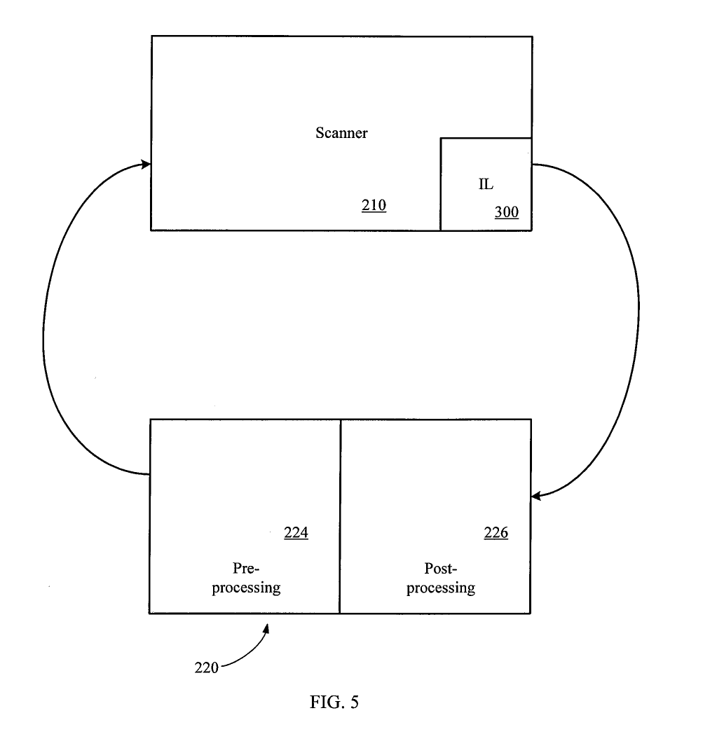

FIG. 5 shows a block diagram of the flow of a wafer between a track 220 and a scanner 210 that includes exposing the wafer with an IL system 300 at the scanner 210 prior to providing the wafer back to the track 220 according to one embodiment. Again, the optics, such as the laser, may be configured to provide illumination for both the OPL and IL exposures. In other embodiments, the two exposures may use different illumination sources with the same or different wavelength. In this embodiment, the OPL exposure occurs first followed by the IL exposure. Performing the IL exposure second may be beneficial because the IL exposure may require tighter tolerances that improve with a shorter duration between IL exposure and post-processing, such as the post exposure bake (PEB).

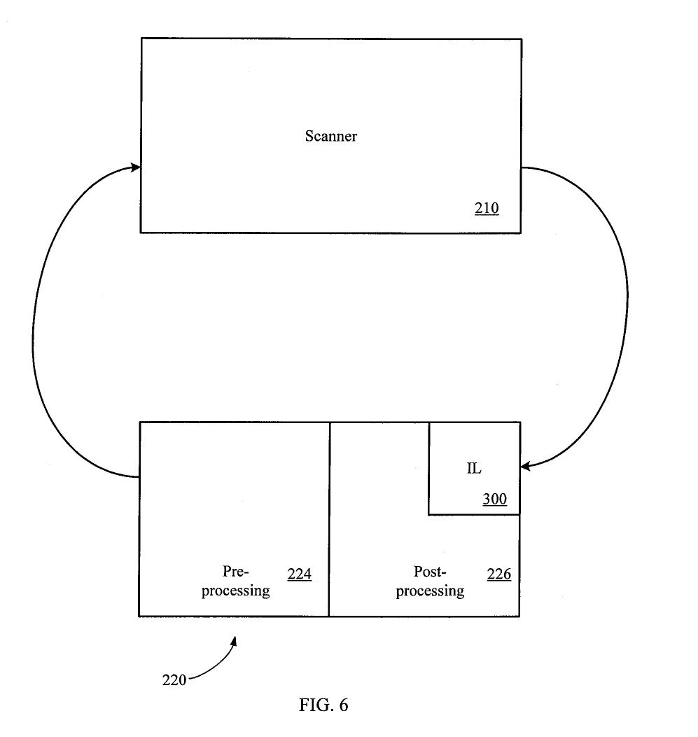

FIG. 6 shows a block diagram of the flow of a wafer between a track 220 and a scanner 210 that includes exposing the wafer with an IL system 300 at the track 220 after receiving the wafer from the scanner 210 according to one embodiment. As in FIG. 3 the track includes, for example, an IL interferometer as part of the IL system 300 that exposes the wafer after the wafer is received from the scanner 210. This embodiment may provide even shorter duration between the IL exposure and the PEB.

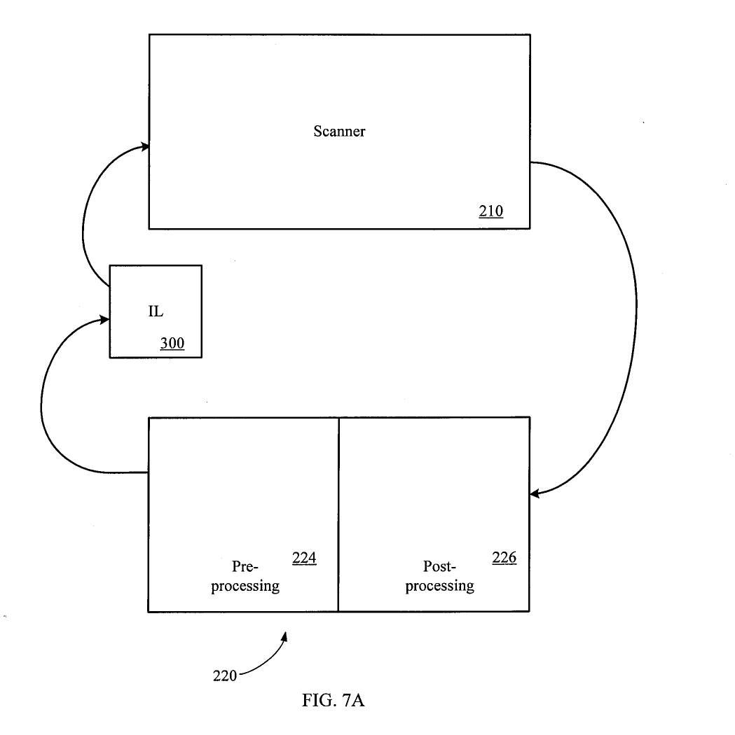

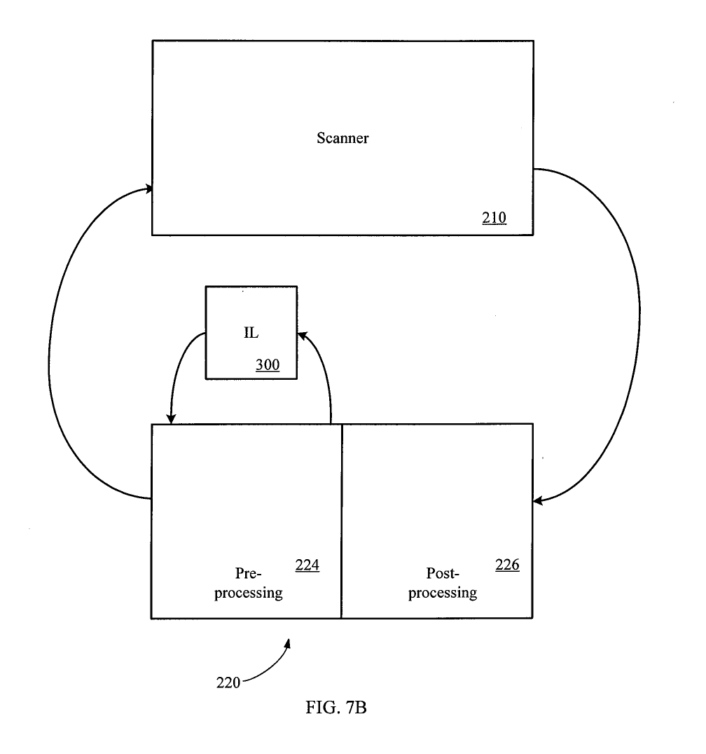

FIG. 7A shows a block diagram of the flow of a wafer between a track 220 and a scanner 210 that includes exposing the wafer with an IL system 300 after preprocessing at the track 220 and prior to exposure at the scanner 210 according to one embodiment. In this embodiment, the track 220 may include a transfer utility that moves the wafer from the track 220 to the IL system 300, and the IL system 300 may include a transfer utility that moves the wafer from the IL system 300 to the scanner 210. In yet another embodiment, the IL system 300 transfers the wafer back to the track after the IL exposure as shown in FIG. 7B. The track 220 may then transfer the wafer to the scanner 210.

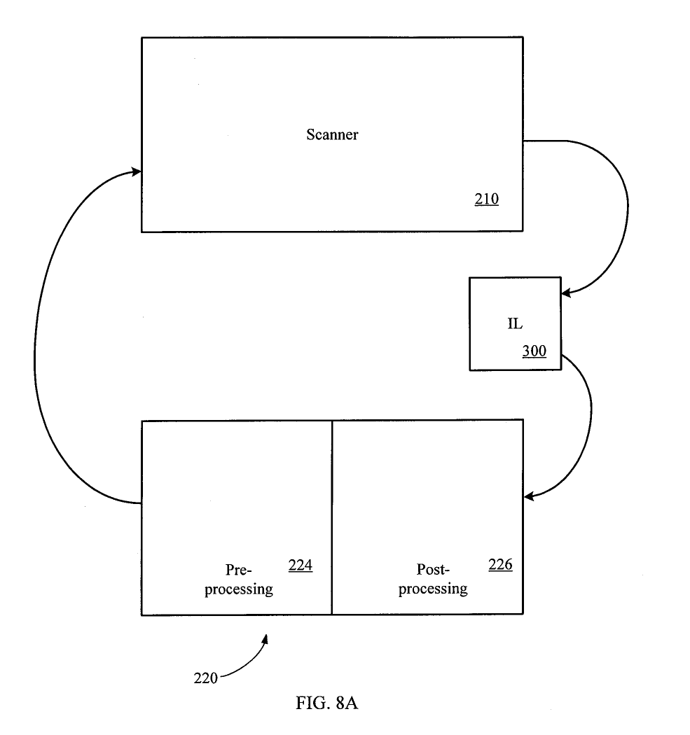

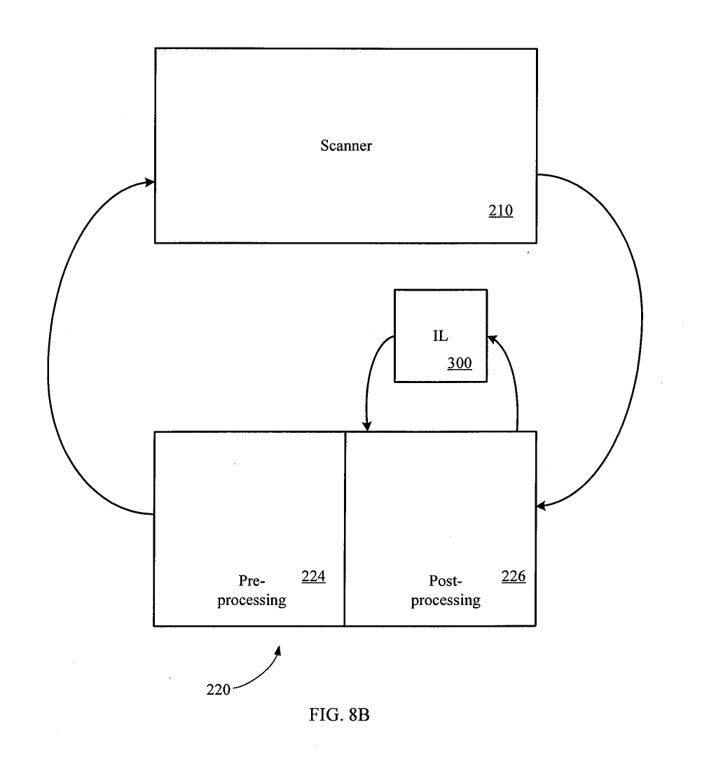

FIG. 8A shows a block diagram of the flow of a wafer between a track 220 and a scanner 210 that includes exposing the wafer with an IL system 300 after exposure at the scanner 210 and prior to post-processing at the track 220 according to one embodiment. In this embodiment, the track 220 may include a transfer utility that moves the wafer from the scanner 210 to the IL system 300. The scanner 210 may also be adapted with a transfer utility. In another embodiment and as shown in FIG. 8B, the track 220 may receive the wafer from the scanner 210, transfer the wafer to the IL system 300, and then retrieve the wafer from the IL system 300 as part of the post-processing. In yet another embodiment shown in FIG. 8B, the track 220 may receive the wafer from the scanner 210, do post-processing to the wafer, coat another photoresist on the wafer in another pre-processing step, transfer to the wafer to the IL system 300, and then retrieve the wafer from the IL system 300 to do another post-processing. The post-processing here may include post-exposure bake, development of photoresist, etching (dry or wet) to transfer the photoresist pattern to an underlying layer.

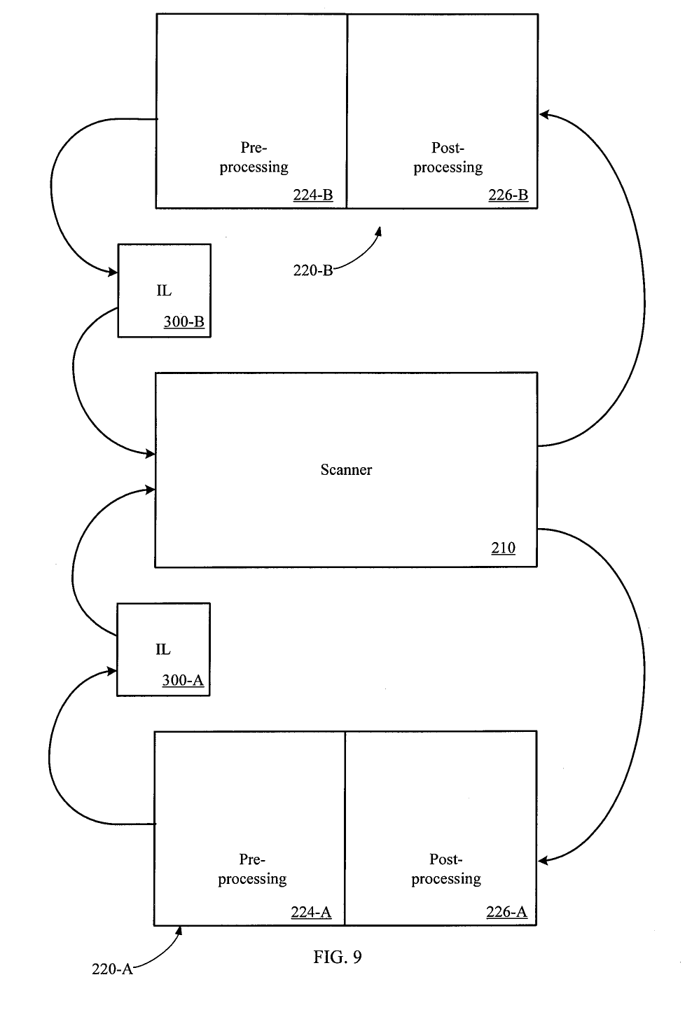

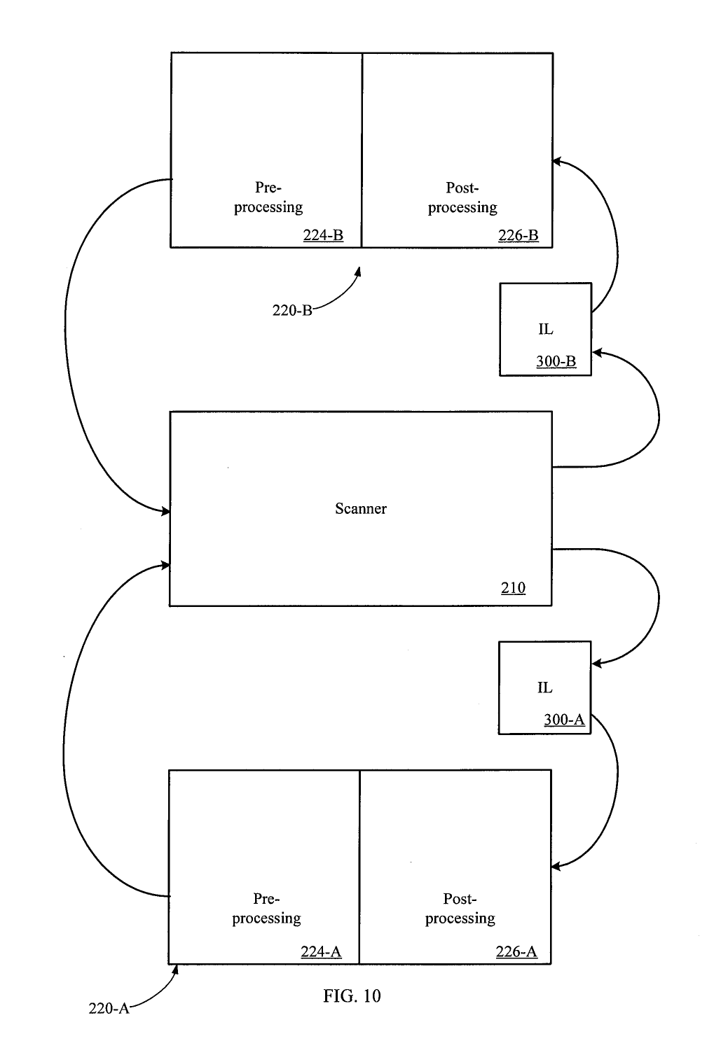

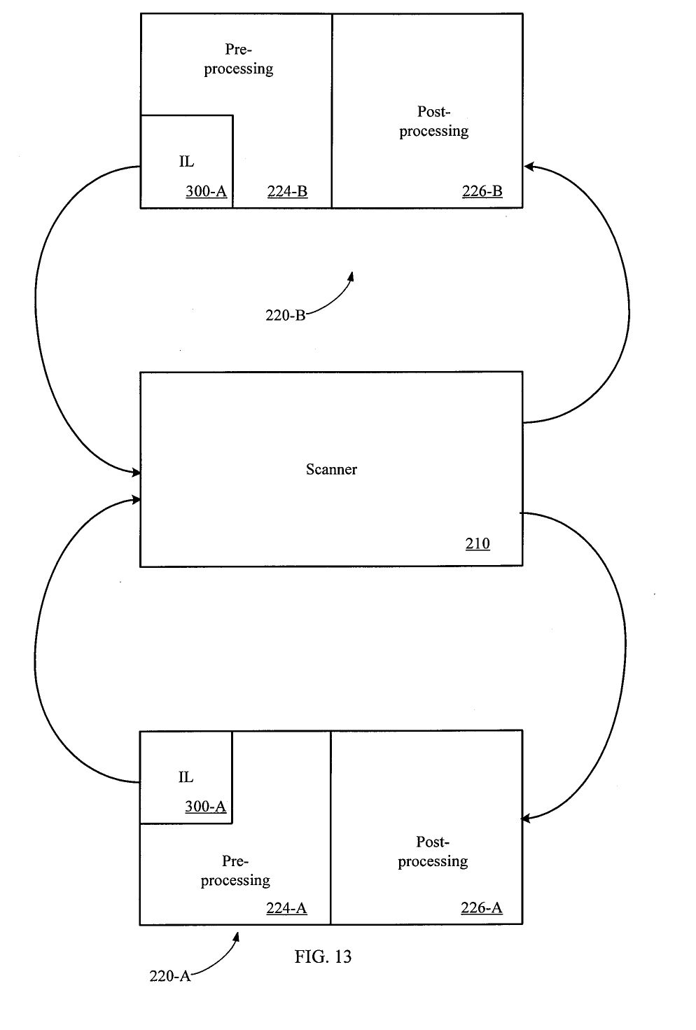

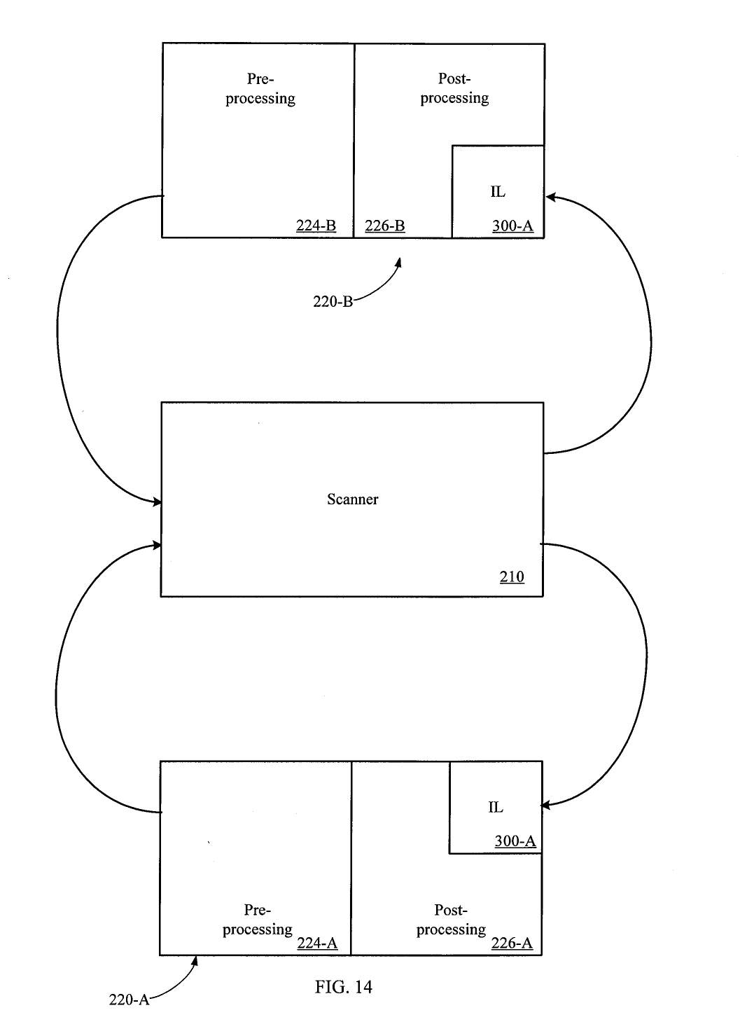

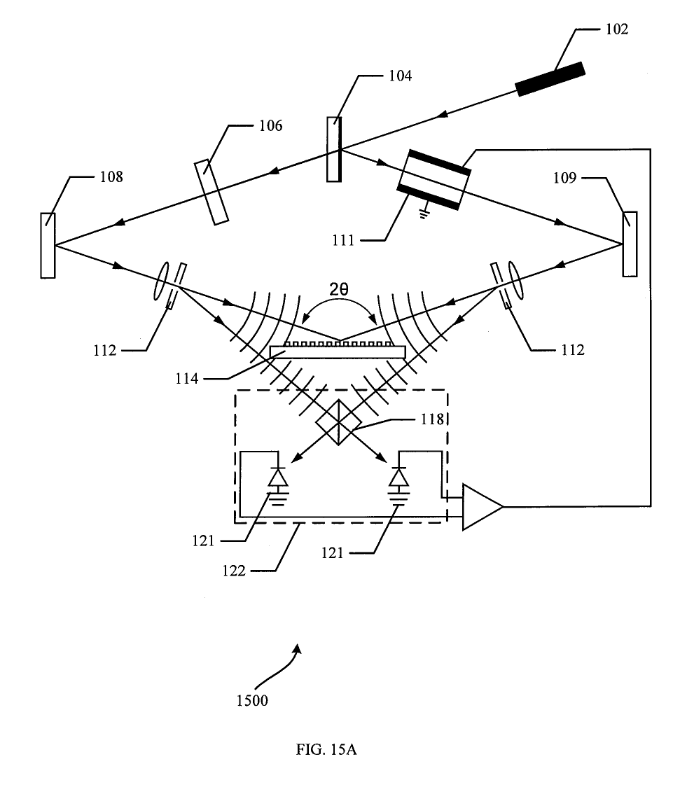

FIG. 9 shows a block diagram of the flow of two sets of wafers from two tracks 220-A, 220-B to one scanner 210 with an IL system 300-A, 300-B between the pre-processing portion of the track 220-A, 220-B and the scanner 210 according to one embodiment. If the scanner 210 can processes wafers faster than the track 220-A, 220-B, then two tracks 220-A, 220-B may feed wafers to a single scanner 210 as shown. In this embodiment, the IL system 300-A, 300-B is independent, but may alternatively be part of the scanner 210 and/or the track 220-A, 200-B as shown in FIGS. 13 and 14.

FIG. 10 shows a block diagram of the flow of two wafers from two tracks 220-A, 220-B to one scanner 210 with an IL system 300-A, 300-B between the post-processing portion of the track 220-A, 200-B and the scanner 210 according to one embodiment. In this embodiment, the IL system 300-A, 300-B is independent, but may alternatively be part of the scanner 210 and/or the track 220-A, 220-B.

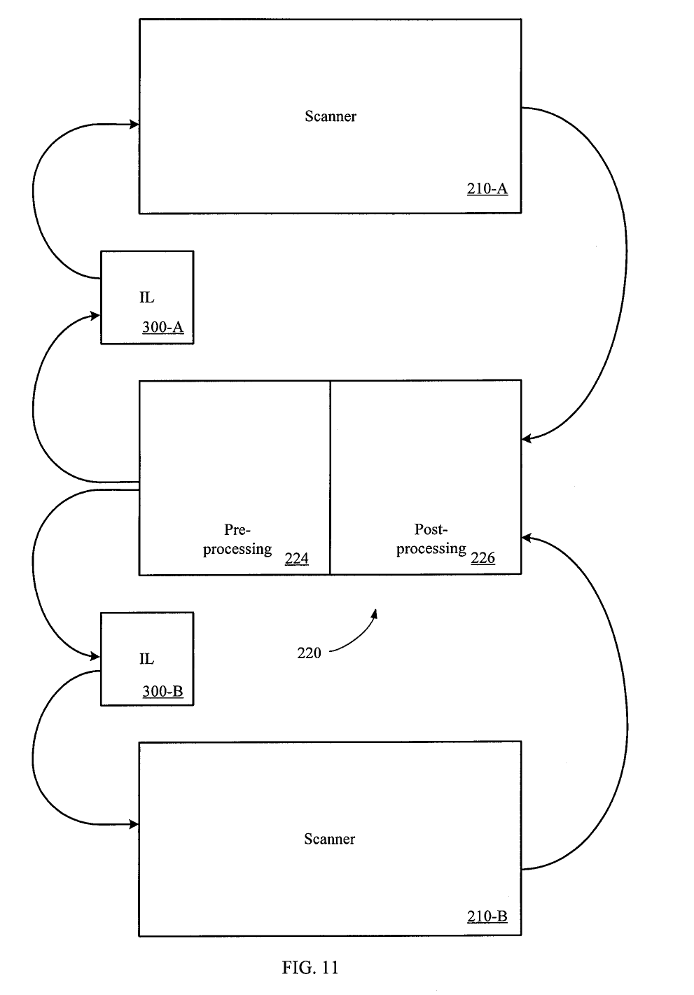

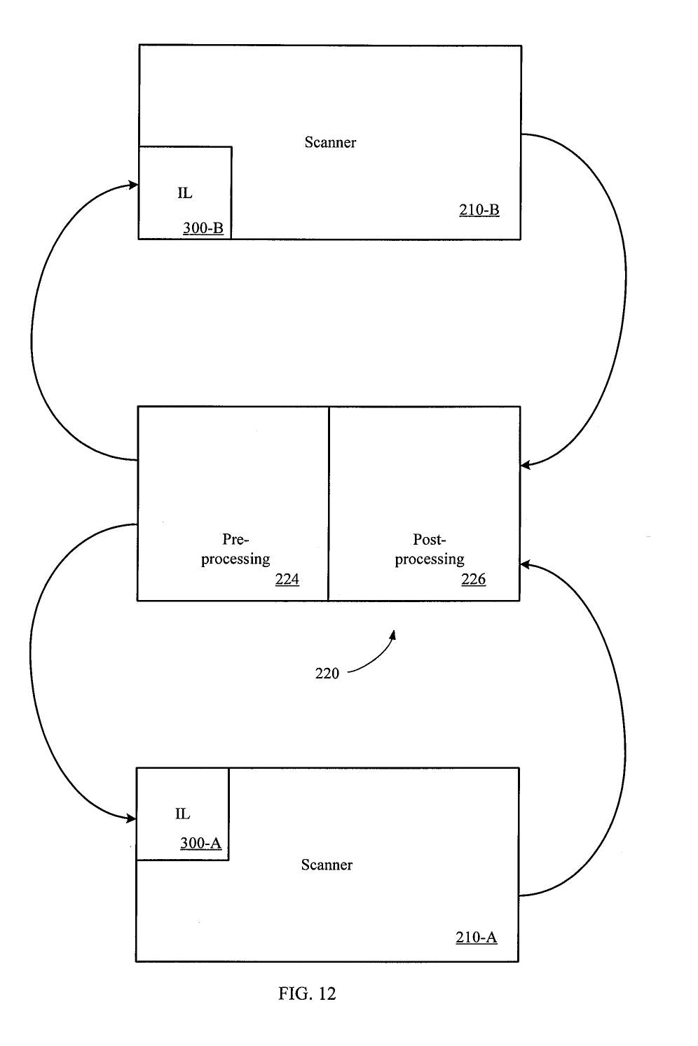

FIG. 11 shows a block diagram of the flow of two wafers from a single track 220 to two scanners 210-A, 210-B with an IL system 300-A, 300-B between the pre-processing portion of the track 220 and the scanner 210-A, 210-B according to one embodiment. If the track 220 is faster than the scanner 210-A, 210-B then a single track 220 may feed two scanners 210-A, 210-B. In this embodiment, the IL system 300-A, 300-B is independent, but may alternatively be part of the scanner 210-A, 210-B and/or the track 220, for example, as shown in FIG. 12.

FIG. 13 shows a block diagram of the process flow from two tracks 220-A, 220-B into a single scanner 210 according to one embodiment. In some embodiments, the pre-processing 224-A, 224-B, IL exposure 300-A, 300-B, and post-processing 226-A, 226-B take significantly longer than the scanner process. In some embodiments, the time require in the scanner is at least half as long. Accordingly, two tracks 220-A, 220-B may feed wafers into the single scanner 210. An interference lithography exposure 300-A, 300-B may occur during pre-processing 224-A, 224-B. FIG. 14 shows a block diagram showing a process flow similar to the process flow shown in FIG. 13 according to one embodiment. The interference lithography exposure 300-A, 300-B occurs during post-processing 226-A, 226-B.

While an IL system is shown as an add-on or an addition module within a scanner-track system other lithography systems may also be used. For example, e-beam lithography or extreme ultraviolet interference lithography (EUV-IL) may also be used in place of the IL system or within the scanner. Various other lithography systems may also be employed within the scanner or in place of the IL system.

Various embodiments may also provide timing controls between the scanner, IL system and/or the track. Efficient movement of wafers from the track to the scanner is ideal. The photo-sensitive resist on the wafer may be degraded if the latency between exposures and PEB is too long. Accordingly efficient timing coordination between the track and/or the scanner may be important. Various software and/or hardware controls may be incorporated in order to efficiently move the wafer between processes.

Interference Lithography

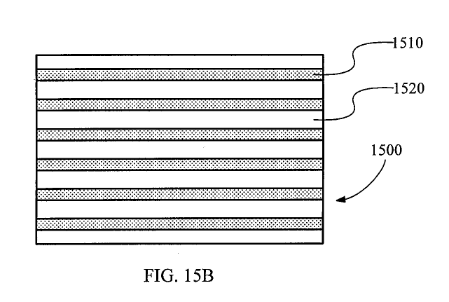

FIG. 15A shows a block diagram of an interference lithography system 100 according to one embodiment. A laser 102 produces a coherent light beam that is split at a beam splitter 104 into two-beams. The laser 102, for example, may comprise an excimer laser. Various other light sources may also be used, for example LEDs broadband sources with a filter, etc. Other light sources may include UV light source from gas-charged lamps such as Hg-lamp at g-line (436 nm) and i-line (365 nm), or EUV light sources at 13.5 nm wavelength from a magnetron or Tin plasma.

Excimer lasers may produce light at various ultraviolet wavelengths. For example, an excimer laser may include an Ar₂ laser producing light with a wavelength of 126 nm, a Kr₂ laser producing light with a wavelength of 146 nm, an F₂ laser producing light with a wavelength of 157 nm, an Xe₂ laser producing light with a wavelength of 172 or 175 nm, an ArF laser producing light with a wavelength of 193 nm, a KrF laser producing light with a wavelength of 248 nm, an XeBr laser producing light with a wavelength of 282 nm, an XeCl laser producing light with a wavelength of 308 nm, an XeF laser producing light with a wavelength of 351 nm, a KrCl laser producing light with a wavelength of 222 nm, a Cl₂ laser producing light with a wavelength of 259 nm, or a N₂ laser producing light with a wavelength of 337 nm. Various other lasers operating in other spectral bands may also be used without deviating from the scope of the present disclosure. The various embodiments will be described using an ArF excimer laser that produces light at 193 nm.

The two-beams created at the beam splitter 104 are reflected toward a target 114 using two mirrors 108, 109. Absent a substrate or other material, the target 114 may be a process chuck. The target may hold a substrate or other material. The beam splitter 104, may include any light splitting element, such as a prism or diffraction grating. The two-beams interfere constructively and destructively at the target 114 creating an interference pattern at the target 114. The position of the interference pattern may depend on the phase difference of the two-beams. The angle θ is the angle of incidence of a single beam with respect to the normal of the target 114. The angle 2θ is the angle between the two-beams at the substrate.

Spatial filters 112 may be included along each beam path. These spatial filters 112 may expand the beams for dose uniformity over a large area. Moreover, the spatial filters 112 may be used to remove spatial-frequency noise from the beams. Due to the potential of relatively long propagation distances (˜1 m) and the lack of additional optics after the spatial filer, the beams interfering at the substrate can be accurately approximated as spherical. Other optical elements may be employed throughout the optical paths of the two-beams of light.

The spatial position of the interference fringes is determined by the relative phase of the beams, which makes this type of interferometer extremely sensitive to path length differences between the two arms. For this reason, a phase difference sensor 122 may be employed in conjunction with a Pockels cell 111 in one arm of the interference lithography system 100. The phase difference sensor 122 may include another beam splitter 118 and two photodiodes 121. Differential changes in the intensity on the photodiodes 121 may be converted into phase differences. The phase difference may then be adjusted at the Pockels cell 111. A variable attenuator 106 in the arm that does not have the Pockels cell 111 may be employed to balance any power lost through the Pockels cell 111.

The Pockels cell 111 may include any device that includes a photo refractive electro-optic crystal and/or a piezoelectric element that can change the polarization and/or phase of a light beam in response to an applied voltage. The phase may be changed by varying the index of refraction of the Pockels cell in response to the applied voltage. When a voltage is applied to this crystal it can change the phase of the light beam. In some Pockels cells, the voltage, V, required to induce a specific phase change, φ, φ, can be calculated, for example, by the following equation:

$$V = \frac{φ}{π} {V}_{\frac{λ}{2}} ,$$

where

$${V}_{\frac{λ}{2}} {V}_{\frac{λ}{2}}$$

is the half wavelength voltage, which depends on the wavelength, λ, of the light beam passing through the Pockels cell. The Pockels cell may comprise, for example, an oxide of bismuth and germanium or of bismuth and silicon. Most importantly, the Pockels cell may include any device or material that may tune the phase of light in the presence of an applied voltage.

The Pockels cell may be replaced with an optical element that varies the optical path distance through the optical element. The optical path distance through the optical element may be change by rotating the optical element or by flexing the width of the optical element. The optical path distance may change using a mechanical devices or piezoelectrics. To induce a 180° phase change, for example, the optical element should increase the optical path distance by:

$$d = \frac{λ}{2 n} ,$$

where n is the index of refraction of the optical element. Accordingly, change in distance by either rotating the optical element or flexing is a fraction of the wavelength of the light beam passing through the optical element.

In various embodiments, the phase difference between the first exposure and the second exposure is not necessarily 180°. For example, a phase difference of 120° may be used between three exposures. Moreover, a phase difference of 90° may be used between four exposures. In other embodiments, various other phase differences between various exposures may be used to vary the width or placement of exposed portions of the nonlinear photoresist.

The Pockels cell may be used to align the phases of the two light beams within the interferometer as well as to adjust the phase difference between the two light beams so that they are 180° out of phase.

FIG. 15B illustrates a latent or real image of an interference pattern 1500 of spaces 1520 (exposed to light) and lines 1510 (not exposed to light) produced by the interference lithography apparatus 100 of FIG. 15A on the surface of the target 114. “Latent” refers to a pattern on a photoresist which experienced a chemical reaction due to radiation but has not yet been developed in a solution to remove the exposed areas of the positive tone photoresist. The lines 1510 have a substantially equal width. The spaces 1520 may or may not have a width equal to the width of the lines 1510.

The pitch is a sum of a line width 1510 and a space width 1520 as shown in FIG. 15B. The half pitch (HP) is a measure of the minimum pitch which can be resolved by a projection optical exposure apparatus with a pre-determined wavelength λ and numerical aperture (NA). HP may be expressed as:

$$H P = \frac{( {k}_{1} \frac{λ}{n} )}{N A}$$

where NA is the numerical aperture of a projection lens in the lithography tool, n₁ is the refractive index of a media between the substrate and the last element of the optical projection system, and k₁ is Rayleigh's constant. Some optical projection systems currently in use for microlithography use air, for which n₁=1. For liquid immersion microlithographic systems, n₁>1.4. For n₁=1, HP may be expressed as:

$$H P = \frac{{k}_{1} λ}{N A} .$$

Using an ArF excimer laser the wavelength, λ, is 193 nm. A minimum available k₁ value is approximately 0.28 and the maximum NA may be just below 1 Realistically NA's of 0.93 are achieved in production. Accordingly, the smallest HP achievable with such a system may be approximately 54 nm and is often referred to as Rayleigh's limit. Other systems employing such things as immersion lithography may bring HP near 32 nm. Some embodiments may provide an HP less than 32 nm.

In another embodiment, the target 114 includes a photoresist with nonlinear, super-linear or memoryless properties. Such a photoresist may have a limited response period. The photoresist may be a thermal photoresist. The terms memoryless photoresist, nonlinear photoresist, super-linear photoresist, and thermal photoresist may be used interchangeably throughout this disclosure despite not being perfectly synonymous. Such photoresists may be broadly characterized by the fact that the photoresist does not integrate energies of consecutive exposures, as long as none of the energy exceeds a threshold, and there is time period (or sufficient cool-down time) between them. Moreover, nonlinear photoresists may only integrate energies of incident light as long as the incident light exceeds a threshold.

The intensity of light, I₁₂, incident at the target 114 using the interferometer shown in FIG. 15 can be written as:

I₁₂=I₁+I₂+2(\vec{E}₁·\vec{E}₂)cos┌(\vec{k}₁−\vec{k}₂)·\vec{r}+Δφ┘,

where I₁ and I₂ are the intensities of light from the first and second arms of the interferometer, \vec{E}E₁ \vec{E}₁ and \vec{E}₂ \vec{E}₂ are the first and second electric fields associated with the incident light, and \vec{k}₁ \vec{k}₁, and \vec{k}₂ \vec{k}₂ are the respective wave vectors. Furthermore, \vec{r}\vec{r} is the position vector and Δφ Δφ is the phase difference of the two incident beams of light. Intensity maxima is found when the cosine term equals zero:

(\vec{k}₁−\vec{k}₂)·\vec{r}+Δφ=0.

A 2 beam interference pattern may include a series of lines where the photoresist is not exposed to light and a series of spaces where the photoresist is exposed to light with a positive photoresist and vice-versa with a negative photoresist. By carefully controlling the phase difference between the two incident beams of light so that a second exposure uses a phase difference that is about 180° different from the first phase difference the interferometer may expose the surface of the target with a plurality of substantially parallel lines.

Electron Beam Lithography

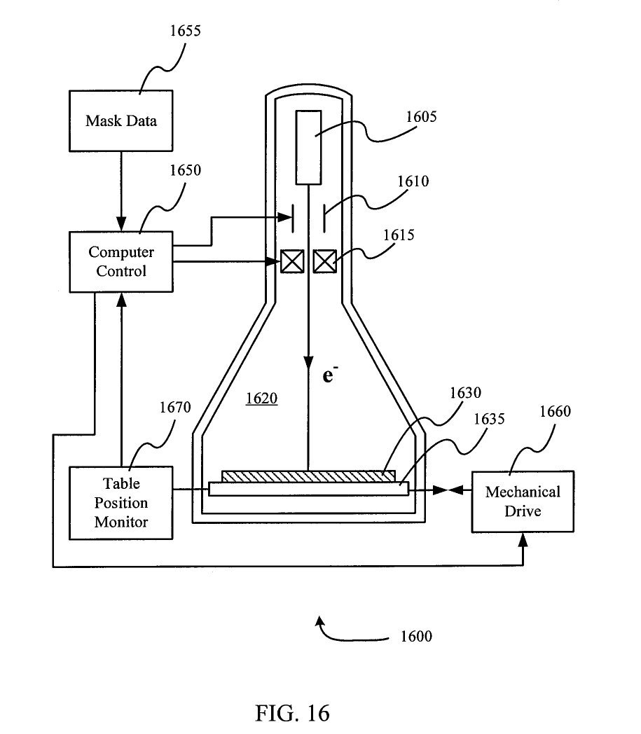

FIG. 16 shows a schematic diagram of a representative electron beam apparatus 1600 that may be used in some embodiments. An electron source or gun 1605 is shown positioned above a target 1630 within a vacuum chamber 1620. The target may include a substrate with any number of labels, such as, a photoresist layer. The target may rest on a mechanical table 1635. The electron source 1605 may be, for example, a tungsten thermionic source, an LaB₆ source, cold field emitter, or a thermal field emitter. Various electron optics may also be included, for example, one or more lenses, a beam deflector 1615, a blanker for turning the beam on and off 1610, a stigmator for correcting any astigmatism in the beam, apertures for helping to define the beam, alignment systems for centering the beam in the column, and/or an electron detector for assisting with focusing and locating marks on the sample.

The electron beam apparatus 1600 may include a beam deflector 1615 to scan the electron beam across the target 1630. The beam deflector 1610 may be magnetic or electrostatic. In some embodiments, coils or plates may be used to magnetically or electrostatically deflect the electron beam. For example, four deflectors may be placed around the electron beam to deflect the electron beam toward positions on the target 1630.

The electron beam apparatus 1600 may also include beam blankers 1610 used to turn the beam on or off. The beam blankers 1610 may include electrostatic deflector plates that deflect the electron beam away from the target 1630. In some embodiments, one or both of the plates may be coupled with an amplifier with a fast response time. To turn the beam off, a voltage is applied across the plates which sweeps the beam off axis.

Control of the electron beam may be directed by a computer 1650 or any other processing machine. The computer 1650 may receive mask data 1655 from any source. The mask data 1655 describes coordinates of the desired incidence of the electron beam. The computer 1650 may use the mask data 1655 to control the beam deflectors 1615, the beam blankers 1610 and/or the mechanical drive 1660 that is coupled with the mechanical table 1635. Signals may be sent to the beam deflectors 1615 to control the deflection of the electron beam so that it is pointed at a specific location on the table. A table position monitor 1670 may be used to detect the relative position of the mechanical table and inform the computer accordingly.

Optical Lithography

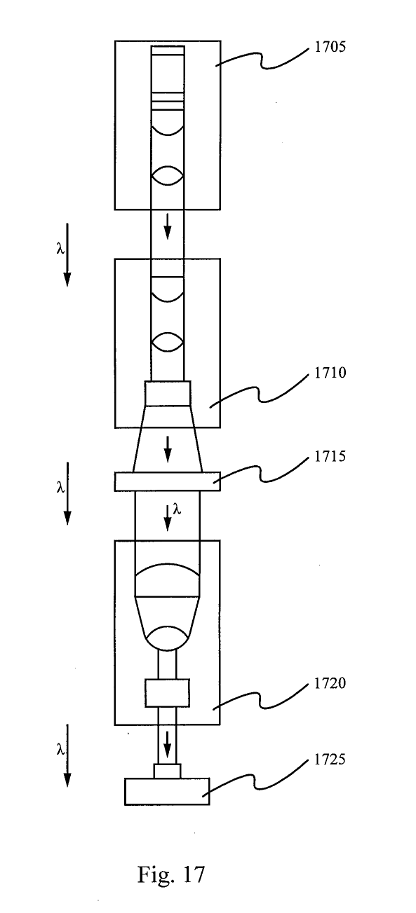

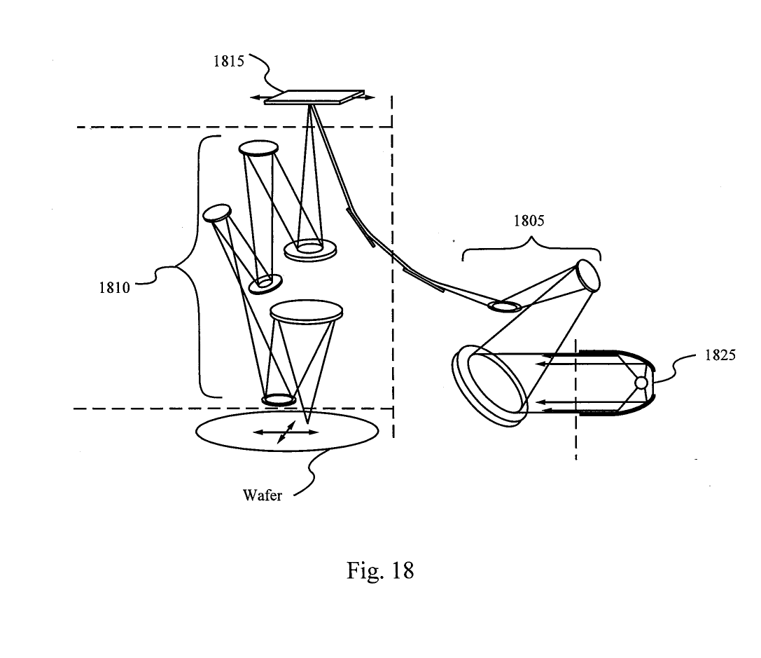

FIG. 17 shows an example schematic of an OPL projection stepper or scanner system according to one embodiment. As shown, a radiation source 1705 is used to direct light through illumination system optics 1710. The radiation source, for example, may be an excimer laser, which operates at wavelengths below 300 nm. Some krypton fluoride radiation sources, for example, provide 248-nm light, and argon fluoride radiation sources produce a 193-nm light. In other embodiments the radiation source may produce ultraviolet light from gas-discharge lamps using mercury, sometimes in combination with noble gases such as xenon. These lamps produce light across a broad spectrum with several strong peaks in the ultraviolet range. In such embodiments, the spectrum may be filtered to select a single spectral line, usually the “g-line” (436 nm) or “i-line” (365 nm).

In some embodiments, the illumination system optically focuses and/or collimates the light prior to the light being incident on the mask 1715. Various optical elements may be used. The mask 1715 may comprise a series of polygons and may be written onto a square fused quartz substrate covered with a layer of chrome using a photolithographic process. For example, a beam of electrons is used to expose the pattern defined in the data file and travels over the surface of the substrate in either a vector or raster scan manner. Where the photoresist on the mask is exposed, the chrome can be etched away, leaving a clear path for the light to travel through. The mask may contain a pattern that is to be exposed on the wafer.

Various projection optical elements 1720 may be used to project the pattern in the mask onto the wafer 1725. In some embodiments, a projection system is used to project a latent image from the mask on a single die. Such projection systems may project many times to expose the latent image on the wafer. In other embodiments a contact printer may be used, wherein the mask is applied directly onto the wafer. A proximity printer may also be used in some embodiments, wherein the mask is provided a small distance above the wafer. In these later two embodiments, the mask covers the entire wafer.

EUV Lithography

While various embodiments described herein may use an EUV lithography system, FIG. 18 shows an example of the optical elements within an EUV lithography system that may be used. In this embodiment, the EUV lithography system includes at least two condenser multilayer mirrors 1805, six projection multilayer mirrors 1810, and a multilayer reflective mask 1815. The optics absorb about 96% of the available EUV light, hence the ideal EUV source 1825 may need to be sufficiently bright. The EUV source may include a plasma generated by a laser and/or a discharge pulse. The mirror responsible for collecting the light is directly exposed to the plasma and may therefore be vulnerable to damage from the high-energy ions and other debris.

The optical system shown in FIG. 18 may take place in a vacuum, in order to mitigate absorption of UV light by air. In some embodiments, the optical elements, including the photomask, may use defect-free Mo/Si multilayers which act to reflect light by means of interlayer interference. In other embodiments a maskless interference lithography system may be used. Such embodiments, for example, may particularly useful in producing periodic patterns.

What is claimed is:

1. A lithography system comprising:
a scanner configured to expose a wafer under an optical condition; and
a track that includes an interference lithography interferometer, wherein the track is configured to provide pre-exposure processing of the wafer, provide the wafer to the scanner, provide post-exposure processing of the wafer, and receive the wafer from the scanner.

2. The lithography system according to claim 1, wherein the interference lithography system is provided as part of the pre-exposure processing.

3. The lithography system according to claim 1, wherein the interference lithography system is provided as part of the post-exposure processing.

4. The lithography system according to claim 1, wherein the optical condition is selected from the group consisting of extreme ultraviolet lithography, electron beam lithography, and optical photolithography.

5. A lithography scanner comprising:
track input means for receiving a wafer from a wafer processing track, wherein the track input means is coupled with a track;
first exposure means for exposing the wafer using a first lithography technique;
second exposure means for exposing the wafer using interference lithography; and
track output means for providing the wafer to the track after exposure, wherein the track output means is coupled with the track.

6. The lithography system according to claim 5, wherein the first exposure means exposes the wafer with the first lithography technique prior the second exposure means exposing the wafer with interference lithography.

7. The lithography system according to claim 5, wherein the first exposure exposes means exposes the wafer with the first lithography technique after the second exposure means exposing the wafer with interference lithography.

8. The lithography system according to claim 5, wherein the lithography technique is selected from the group consisting of extreme ultraviolet lithography, electron beam lithography, and optical photolithography.

9. The lithography system according to claim 5, wherein the interference lithography interferometer comprise a light source with wavelengths selected from the group consisting of ultraviolet, extreme ultraviolet, and optical.

10. A method for exposing a wafer comprising:
providing pre-exposure processing of the wafer within a track;
exposing the wafer with an interference lithography system within the track;
transferring the wafer from the track to a scanner;
exposing the wafer within a scanner using a lithography technique;
transferring the wafer from the scanner to the track; and
providing post-exposure processing of the wafer within the track.

11. The lithography system according to claim 10, wherein the lithography technique is selected from the group consisting of extreme ultraviolet lithography, electron beam lithography, and optical photolithography.

12. The lithography system according to claim 10, wherein the pre-exposure processing includes depositing a photoresist layer on the wafer.

13. A method for exposing a wafer comprising:
providing pre-exposure processing of the wafer within a track;
transferring the wafer from the track to a scanner;
exposing the wafer within the scanner using a lithography technique;
transferring the wafer from the scanner to the track;
exposing the wafer with an interference lithography system within the track; and
providing post-exposure processing of the wafer within the track.

14. The lithography system according to claim 13, wherein the lithography technique is selected from the group consisting of extreme ultraviolet lithography, electron beam lithography, and optical photolithography.

15. The lithography system according to claim 13, wherein the pre-exposure processing includes depositing a photoresist layer on the wafer.

16. A method for exposing a wafer comprising:
providing pre-exposure processing of the wafer within a track;
transferring the wafer from the track to a scanner;
exposing the wafer within a scanner using a lithography technique;
exposing the wafer with an interference lithography system within the scanner;
transferring the wafer from the scanner to the track; and
providing post-exposure processing of the wafer within the track.

17. The lithography system according to claim 16, wherein the pre-exposure processing includes depositing a photoresist layer on the wafer.

18. The lithography system according to claim 16, wherein the lithography technique is selected from the group consisting of extreme ultraviolet lithography, electron beam lithography, and optical photolithography.

19. A method for patterning a wafer comprising:
coating the wafer with a first photoresist layer within a track;
transferring the wafer from the track to an interference lithography system;
exposing the wafer with the interference lithography system;
transferring the wafer from the interference lithography system to the track;
providing first post-processing of the wafer within the track, wherein the post-processing may include a processing technique selected from the group consisting of: photoresist development, post-exposure baking, and etching;
coating the wafer with a second photoresist layer within the track;
transferring the wafer from the track to a scanner;
exposing the wafer within a scanner using a lithography technique;
transferring the wafer from the scanner to the track; and
providing second post-processing of the wafer within the track, wherein the post-processing may include a processing technique selected from the group consisting of: photoresist development, post-exposure baking, and etching.

20. The lithography system according to claim 19, wherein the lithography technique is selected from the group consisting of extreme ultraviolet lithography, electron beam lithography, and optical photolithography.
